(19) United States
(12) Patent Application Publication
(10) Pub. No.: US 2010/0262384 A1
(43) Pub. Date: Oct. 14, 2010

(54) HIGH TENSION CABLE MEASUREMENT SYSTEM AND ASSEMBLY

(76) Inventors: Umair Marfani, Spring, TX (US); Alvin Rooks, Missouri City, TX (US); Joseph Varkey, Sugar Land, TX (US)

Correspondence Address: SCHLUMBERGER TECHNOLOGY CORPORATION - HCS, 200 GILLINGHAM LANE, MD-2, SUGAR LAND, TX, 77478, US

(21) Appl. No.: 12/755,161

(22) Filed: Apr. 6, 2010

Related U.S. Application Data
(60) Provisional application No. 61/167,288, filed on Apr. 7, 2009.

(51) Int. Cl. G01N 3/08

(52) U.S. Cl. 702/43

(57) ABSTRACT

A tension measurement assembly includes a cable spooled on a spooling device, at least one capstan for directing the cable to a downstream point, and at least one tension measuring device attached to a fixed surface for generating a tension signal indicative of a tension force in the cable. The tension measuring device can include at least one of a tension link, an inclinometer, a tension measuring sheave with a strain axle or load pin, a plurality of load cells, and a freewheeling sheave mounted on a post instrumented with a strain gauge. The tension force is calculated from the tension signal and a cable angle of the cable at the tension measuring device.

### CROSS-REFERENCE TO RELATED APPLICATION

This application is entitled to the benefit of, and claims priority to, provisional patent application Ser. No. 61/167,288 filed Apr. 7, 2009, the entire disclosure of which is incorporated herein by reference.

### BACKGROUND OF THE INVENTION

The statements in this section merely provide background information related to the present disclosure and may not constitute prior art.

The invention is related in general to wellsite surface equipment such as wireline surface equipment and the like.

Conventional logging cables are stored on drums with tension profiles to match the tensions the cable will encounter when deployed in a well. A great deal of the tension is related to a weight of the cable deployed in the well. With the newer, longer cables being used in off-shore wells, the increased cable weights result in higher tensions. If unabated, these tensions would be sufficient to crush the cable on the drum or cause the drum to collapse.

Given the potential dangers to equipment and personnel associated with wireline cables failing under high tension, it is crucial that the tension is accurately monitored to prevent overstress of the cables.

During deployment and retrieval, a line tension of a logging cable tension is typically monitored using a Cable-Mounted Tension Device (CMTD) which is installed on a truck.

FIG. 1 illustrates a tension measurement assembly 10 according to the prior art. As shown, the assembly 10 includes a drum 12 for spooling a cable 14, a plurality of sheaves 16, 18 for directing the cable 14, and a capstan device 20 disposed in line with the cable 14 between the drum 12 and a lower one of the sheaves 16 to reduce an amount of tension on the drum 12. A pair of CMTDs 22 are utilized, wherein one of the CMTDs 22 is coupled to the cable 14 at a high-tension side of the capstan 20, ‘downstream’ of the capstan 20 and one of the CMTDs 22 is coupled to the cable 14 on a low-tension side, ‘upstream’ of the capstan 20. Each CMTD 22 is fixed relative to the cable 14 for measuring the tension force present in the cable as it passes through the CMTD.

FIGS. 2A-2C are schematic views of the capstan 20 according to the prior art. As shown, the capstan 20 includes a pair of multi-grooved wheels 24 that are offset from one another and tilted so as to permit the cable 14 to leave a groove on one of the wheels 24 and enter the center of a groove on the other of the wheels 24. The orientation of the grooves on the wheels 24 limits a twisting motion imparted on the cable 14 by the drum 12. A diameter of the wheels 24 in the capstan 20 is preferably the same as that of the sheaves 16, 18 to ensure that the cable 14 is not bent beyond its minimum bend radius.

In current systems and/or methods, a Cable-Mounted Tension Device (CMTD) may be less accurate under high strain due to the strain axle used to measure the tension. Additionally, an accuracy of the CMTD may be compromised as the wheels of the CMTD begin to wear under high tensions.

More accurate assemblies, systems, and methods are needed for measuring the tension of a cable under high tension. It also remains desirable to provide improvements in wellsite surface equipment in efficiency, flexibility, reliability, and maintainability.

### SUMMARY OF THE INVENTION

An embodiment of a tension measurement assembly includes a cable spooled on a spooling device, at least one capstan for directing the cable to a downstream point, and at least one tension measuring device attached to a fixed surface for providing a measurement indicative of a tension in the cable.

In an embodiment, a system for measuring the tension of a cable includes: a spooling device having a means to deploy and retrieve the cable; a capstan having a plurality of multi-grooved wheels for directing the cable to a downstream point; a tension measuring device coupled to a fixed surface for providing a measurement indicative of a tension in the cable; and a processor for computing the tension in the cable based on the measurement of the tension measuring device.

The invention also includes methods for measuring a tension of a cable.

In an embodiment, a method comprises the steps of: providing a spooling device having a means to deploy and retrieve the cable; directing the cable to a downstream point; providing a tension measuring device coupled to a fixed surface to detect a measurement indicative of a tension in the cable; and calculating the tension in the cable based on the measurement of the tension measuring device.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic representation of a tension measurement system and assembly according to the prior art;

FIGS. 2A, 2B and 2C are top plan, side elevation and front elevation schematic representations respectively of a capstan of the measurement assembly of FIG. 1;

FIG. 3 is a schematic representation of a tension measurement system and assembly according to an embodiment of the present invention;

FIG. 4 is a schematic representation of a tension measurement system and assembly according to a second embodiment of the present invention;

FIG. 5 is a schematic representation of a tension measurement system and assembly according to a third embodiment of the present invention;

FIG. 6 is a schematic representation of a tension measurement system and assembly according to a fourth embodiment of the present invention;

FIG. 7 is a schematic representation of a tension measurement system and assembly according to a fifth embodiment of the present invention;

FIG. 8 is a schematic representation of a tension measurement system and assembly according to a sixth embodiment of the present invention;

FIGS. 9A, 9B, and 9C are schematic representations of a tension measurement system and assembly according to a seventh embodiment of the present invention; and

FIGS. 10A and 10B are schematic representations of a tension measurement system and assembly according to an eighth embodiment of the present invention.

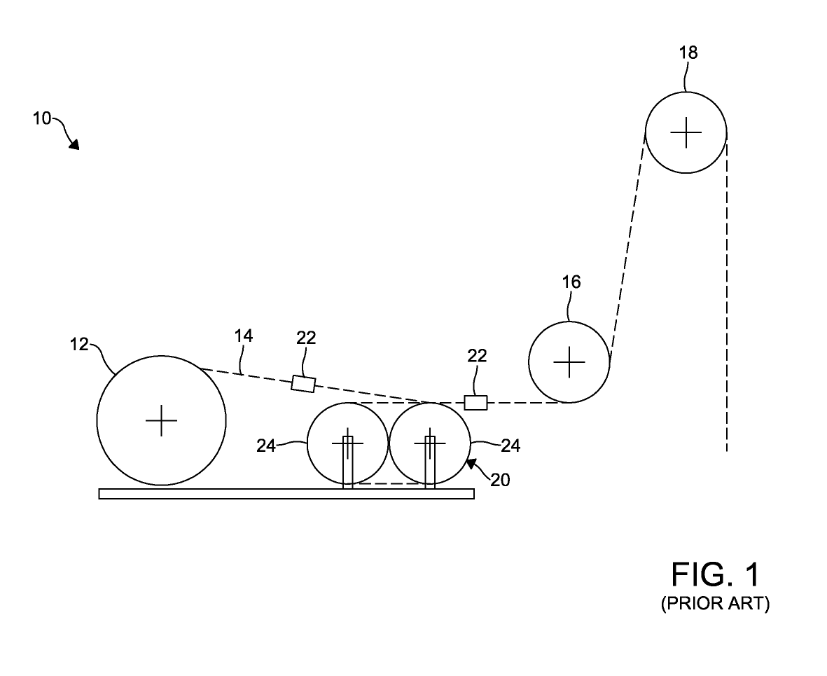

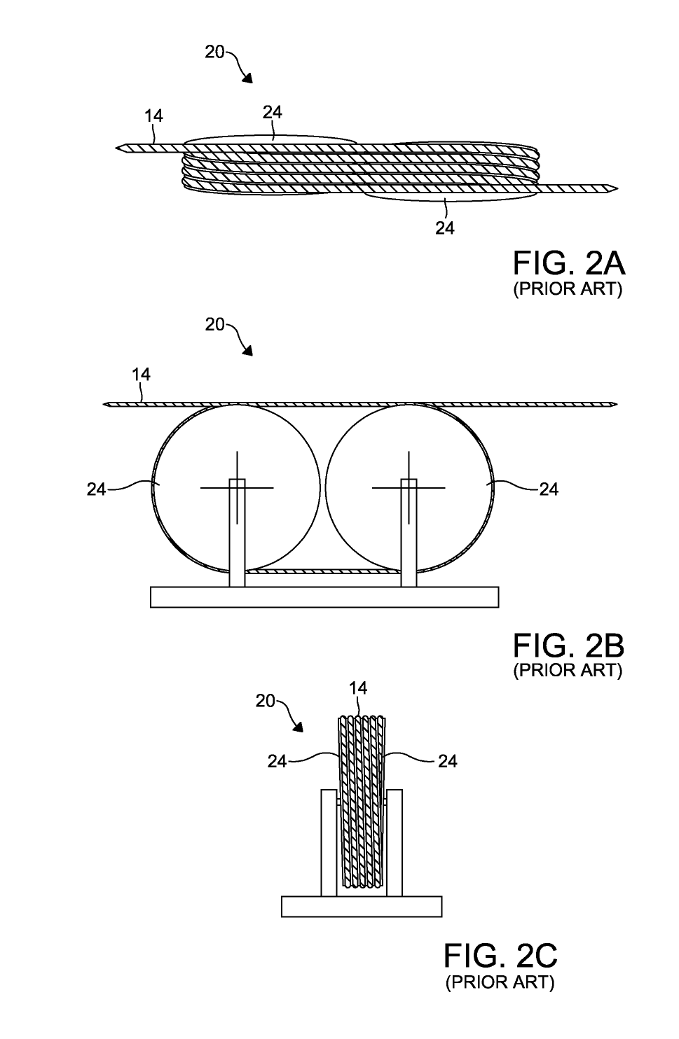

### DETAILED DESCRIPTION OF THE INVENTION

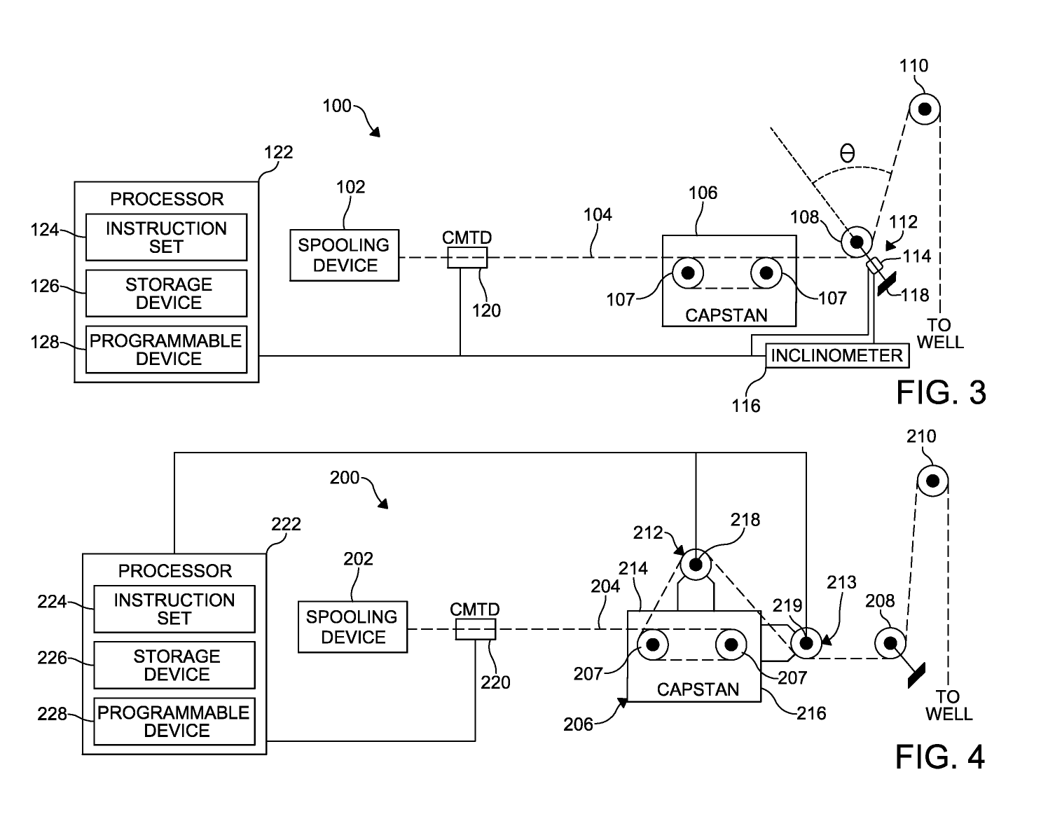

Referring now to FIG. 3, there is shown an embodiment of a tension measurement assembly indicated generally at 100. As shown, the assembly includes a spooling device 102 for spooling a cable 104, a capstan 106 having a plurality of multi-grooved wheels 107, a plurality of sheaves 108, 110 for directing the cable 104, and a tension measuring device 112.

As a non-limiting example, the spooling device 102 is a drum and includes a means to deploy and retrieve the cable 104 such as a winch known in the art.

The capstan 106 is a conventional capstan assembly having a pair of the multi-grooved wheels 107 offset from one another and tilted at a pre-determined angle to permit the cable 104 to leave a groove on one of the wheels 107 and enter the center of a groove on the other one of the wheels 107, as appreciated by one skilled in the art. The cable 104 deploys from the spooling device 102 and travels through the capstan 106.

The first sheave 108 (i.e. bottom sheave or lower sheave) is positioned to receive the cable 104 from the capstan 106. It is understood that the first sheave 108 can be disposed in any position relative to the capstan 106.

The second sheave 110 (i.e. top sheave or upper sheave) is typically disposed in an elevated position relative to the first sheave 108. The second sheave 110 receives the cable 104 from the first sheave 108 and aligns the cable 104 with a pre-determined deployment location such as a wellbore penetrating a subterranean formation, for example. It is understood that the second sheave 110 can be disposed in any position relative to the first sheave 108.

The tension measuring device 112 includes a high-side tension link 114 and an inclinometer 116. The tension link 114 is coupled between a static anchor 118 and the first sheave 108 to measure a force exerted therebetween. The tension link 114 can be any coupler capable of measuring a linear force or strain exerted on the link 114. The inclinometer 116 is disposed to measure a cable angle representing a change in direction of the cable 104 relative to a pre-determined axis as the cable 104 enters and exits the first sheave 108. As a non-limiting example, the inclinometer 116 may be a digital level manufactured by Johnson Level & Tool Mfg. Co., Inc. of Mequon, Wis. However, other devices for measuring an angle of the cable can be used.

In certain embodiments, a Cable-Mounted Tension Device (CMTD) 120 is coupled to the cable 104 between the spooling device 102 and the capstan 106 (i.e. the low tension side).

In certain embodiments, a processor 122 is in data communication with at least one of the tension measuring device 112 and the CMTD 120. As shown, the processor 122 analyzes and evaluates a received data based upon an instruction set 124. The instruction set 124, which may be embodied within any computer readable medium, includes processor executable instructions for configuring the processor 122 to perform a variety of tasks and calculations. It is understood that the instruction set 124 may include at least one of an algorithm, a mathematical process, and an equation for calculating a tension of the cable 104. It is further understood that the processor 122 may execute a variety of functions such as controlling various settings of the tension measuring device 112 and CMTD 120, for example.

As a non-limiting example, the processor 122 includes a storage device 126. The storage device 126 may be a single storage device or may be multiple storage devices. Furthermore, the storage device 126 may be a solid state storage system, a magnetic storage system, an optical storage system or any other suitable storage system or device. It is understood that the storage device 126 is adapted to store the instruction set 124. Other data and information may be stored in the storage device 126 such as the parameters calculated by the processor 122, for example. It is further understood that certain known parameters may be stored in the storage device 126 to be retrieved by the processor 122.

As a further non-limiting example, the processor 122 includes a programmable device or component 128. It is understood that the programmable component 128 may be in communication with any other component of the tension measurement assembly 100 such as the tension measuring device 112 and the CMTD 120, for example. In certain embodiments, the programmable component 128 is adapted to manage and control processing functions of the processor 122. Specifically, the programmable component 128 is adapted to control the analysis of the data received by the processor 122. It is understood that the programmable component 128 may be adapted to store data and information in the storage device 126, and retrieve data and information from the storage device 126.

In use, the cable 104 is deployed and retrieved by the spooling device 102. As the cable 104 is routed through the capstan 106 and the sheaves 108, 110, a tension signal representing the tension force in the cable is generated by the tension link 114 and an angle signal representing an entrance/exit cable angle of the cable 104 at the first sheave 108 is generated by the inclinometer 116. Specifically, a tension in the cable 104 at the high tension side of the capstan 106 is computed using the tension (referred to as a TD-L Tension) measured by the tension link 114 and the cable angle (0) measured by the inclinometer 116. As a non-limiting example the following equation can be used to calculate a tension in the cable 104: CT=MT/(2×cos θ). CT is the cable tension and MT is the measured tension sensed by the tension measuring device 112. The cosine of an angle in a right triangle formed between the hypotenuse and an adjacent side is equal to the length of the adjacent side divided by the length of the hypotenuse. In FIG. 3, the cable angle θ is equal to one half of the angle between the cable entrance to and exit from the first sheave 108. The force vector representing the measured tension is the adjacent side and the force vector representing the cable tension is the hypotenuse. Since the measured tension is the result of the cable tension applied at both the entrance to and exit from the first sheave 108, the measured tension must be divided by two.

However, it is understood that other equations, formulas, and algorithms can be used to calculate a tension in the cable 104.

Referring now to FIG. 4, there is shown an embodiment of a tension measurement assembly indicated generally at 200 similar to the tension measurement assembly 100 except as described herein below. As shown, the assembly 200 includes a spooling device 202 for spooling a cable 204, a capstan 206 having a plurality of multi-grooved wheels 207, a plurality of sheaves 208, 210 for directing the cable 204, and a plurality of tension measuring devices 212, 213.

As a non-limiting example, the spooling device 202 is a drum and includes a means to deploy and retrieve the cable 204 such as a winch known in the art.

The capstan 206 is a conventional capstan assembly having a pair of the multi-grooved wheels 207 offset from one another and tilted at a pre-determined angle to permit the cable 204 to leave a groove on one of the wheels 207 and enter the center of a groove on the other of the wheels 207, as appreciated by one skilled in the art.

The first sheave 208 (i.e. bottom sheave or lower sheave) is positioned to receive the cable 204 from the capstan 206. It is understood that the first sheave 208 can be disposed in any position relative to the capstan 206.

The second sheave 210 (i.e. top sheave or upper sheave) is typically disposed in an elevated position relative to the first sheave 208. The second sheave 210 receives the cable 204 from the first sheave 208 and aligns the cable 204 with a pre-determined deployment location such as a well, for example. It is understood that the second sheave 210 can be disposed in any position relative to the first sheave 208.

The tension measuring devices 212, 213 are each tension-measuring sheaves mounted to the capstan 206. The first tension measuring device 212 is disposed adjacent a top side 214 of the capstan 206. The second tension measuring device 213 is disposed adjacent a front or exit side 216 of the capstan 206. In certain embodiments, the tension measuring devices 212, 213 are coupled in a fixed position relative to each other. As such, the cable angle of the cable 204 entering and exiting the tension measuring devices 212, 213 is fixed and known, thereby eliminating the requirement to measure the angle to compute a tension in the cable 204.

As a non-limiting example, each of the tension measuring devices 212, 213 includes a strain axle 218, 219 or load pin disposed therethrough to measure a force on the tension measuring device 212, 213 due to a tension in the cable 204. As a further non-limiting example, the tension measuring devices 212, 213 are coupled to a fixed surface (i.e. anchor) via a tension link (not shown) similar to the link 114 shown in FIG. 3. Also, one of the devices 212, 213 can simply be a sheave without tension measuring capability.

In certain embodiments, a Cable-Mounted Tension Device (CMTD) 220 is coupled to the cable 204 between the spooling device 202 and the capstan 206 (i.e. the low tension side).

In certain embodiments, a processor 222 is in data communication with at least one of the tension measuring devices 212, 213 and the CMTD 220. As shown, the processor 222 analyzes and evaluates a received data based upon an instruction set 224. The instruction set 224, which may be embodied within any computer readable medium, includes processor executable instructions for configuring the processor 222 to perform a variety of tasks and calculations. It is understood that the instruction set 224 may include at least one of an algorithm, a mathematical process, and an equation for calculating a tension of the cable 204. It is further understood that the processor 222 may execute a variety of functions such as controlling various settings of the tension measuring devices 212, 213 and the CMTD 220, for example. In the embodiment shown, the processor 222 includes a storage device 226 and a programmable component 228.

In use, the cable 204 is deployed and retrieved by the spooling device 202. As the cable 204 is routed through the capstan 206, the sheaves 208, 210, and the tension measuring devices 212, 213, a tension in the cable 204 exerts a force on the strain axle 218, 219 of each of the tension measuring devices 212, 213. The tension in the cable 204 at the high tension side of the capstan 206 is computed using the tension signal (i.e. strain force) generated from at least one of the strain axles 218, 219 and the angle signal representing an exit angle (0) of the cable 204 from the at least one of the tension measuring devices 212, 213. As a non-limiting example the cable angle (θ) of the cable 204 exiting the tension measuring device 212 is known, since each of the tension measuring devices 212, 213 is mounted to a static surface in a generally fixed position relative to the capstan 206. As such, the following equation can be used to calculate a tension in the cable 204: CT=MT/(2×cos θ). CT is the cable tension and MT is the measured strain sensed by the tension measuring devices 212, 213, either individually or as an average of the two measurements.

However, it is understood that other equations, formulas, and algorithms can be used to calculate a tension in the cable 204.

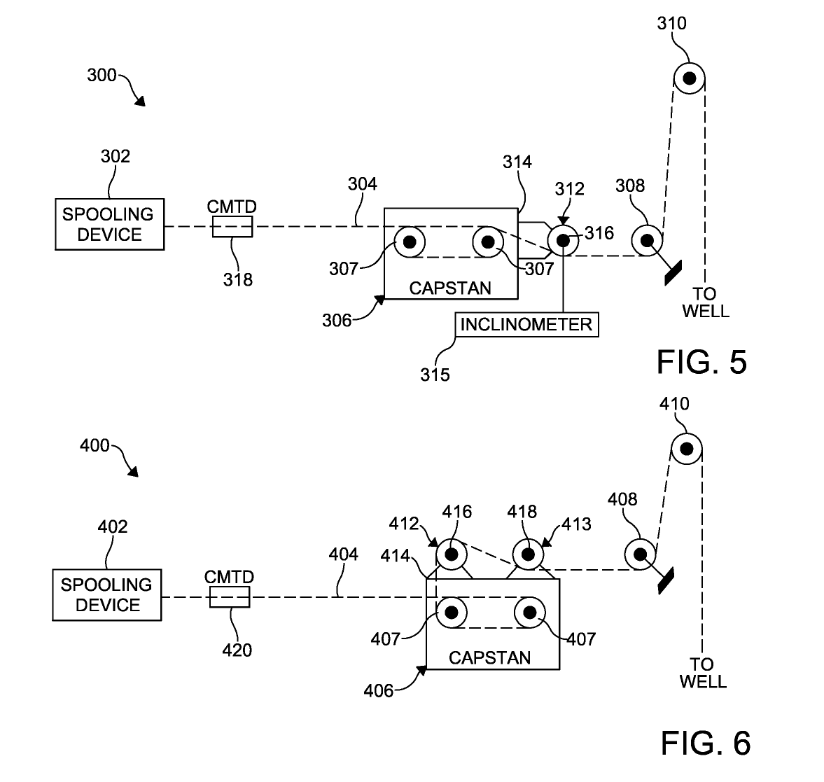

Referring now to FIG. 5, there is shown an embodiment of a tension measurement assembly indicated generally at 300 similar to the tension measurement assembly 100 except as described herein below. As shown, the assembly 300 includes a spooling device 302 for spooling a cable 304, a capstan 306 having a plurality of multi-grooved wheels 307, a plurality of sheaves 308, 310 for directing the cable 304, and a tension measuring device 312.

The tension measuring device 312 includes a sheave mounted to a front surface 314 of the capstan 306 and an inclinometer 315. As a non-limiting example, the tension measuring device 312 includes a strain axle 316 or load pin disposed therethrough to measure a force on the tension measuring device 312 due to a tension in the cable 304. As a further non-limiting example, the tension measuring device 312 is coupled to a fixed surface (i.e. anchor) via a tension link (not shown) similar to the link 114 shown in FIG. 3. The inclinometer 315 is disposed to measure an angle of the cable 304 relative to a pre-determined axis as the cable 304 enters and exits the tension measuring device 312. As a non-limiting example, the inclinometer 315 may be a digital level manufactured by Johnson Level & Tool Mfg. Co., Inc. However, other devices for measuring a cable angle of the cable can be used.

In certain embodiments, a Cable-Mounted Tension Device (CMTD) 318 is coupled to the cable 304 between the spooling device 302 and the capstan 306 (i.e. the low tension side).

In use, the cable 304 is deployed and retrieved by the spooling device 302. As the cable 304 is routed through the capstan 306, the sheaves 308, 310, and the tension measuring device 312, a tension in the cable 304 exerts a force on the strain axle 316 of the tension measuring device 312. The tension in the cable 304 at the high tension side of the capstan 306 is computed using the force (strain force) measured by the strain axle 316 and an exit angle (θ) measured by the inclinometer 315. As a non-limiting example the following equation can be used by the processor 122, 222 to calculate a tension in the cable 304: CT=MT/(2×cos θ). CT is the cable tension and MT is the measured strain sensed by the tension measuring device 312.

Referring now to FIG. 6, there is shown an embodiment of a tension measurement assembly indicated generally at 400 similar to the tension measurement assembly 200 except as described herein below. As shown, the assembly includes a spooling device 402 for spooling a cable 404, a capstan 406 having a plurality of multi-grooved wheels 407, a plurality of sheaves 408, 410 for directing the cable 404, and a plurality of tension measuring devices 412, 413.

The tension measuring devices 412, 413 are each tension-measuring sheaves mounted to the capstan 406. The first tension measuring device 412 is disposed adjacent a top side 414 of the capstan 406. The second tension measuring device 413 is disposed adjacent the first tension measuring device 412 on the top side 414 of the capstan 406, wherein the second tension measuring device 413 is adapted to receive the cable 404 from the first tension measuring device 412. It is understood that the tension measuring devices 412, 413 can be disposed in a fixed position relative to each other so that the cable angle of the cable 404 entering and leaving the tension measuring sheave 412 is fixed, therefore eliminating the requirement to measure the cable angle to compute the tension.

As a non-limiting example, each of the tension measuring devices 412, 413 includes a strain axle 416, 418 or load pin disposed therethrough to measure a force on the tension measuring device 412, 413 due to a tension in the cable 404. As a further non-limiting example, the tension measuring devices 412, 413 are coupled to a fixed surface (i.e. anchor) via a tension link (not shown) similar to the link 114 shown in FIG. 3.

In certain embodiments, a Cable-Mounted Tension Device (CMTD) 420 is coupled to the cable 404 between the spooling device 402 and the capstan 406 (i.e. the low tension side).

In use, the cable 404 is deployed and retrieved by the spooling device 402. As the cable 404 is routed through the capstan 406, the sheaves 408, 410, and the tension measuring devices 412, 413, a tension in the cable 404 exerts a force on the strain axle 416, 418 of each of the tension measuring devices 412, 413. The tension in the cable 404 at the high tension side of the capstan 406 is computed by the processor 122, 222 using the force (strain force) measured by the strain axle 416 and a known cable angle (θ). As a non-limiting example the following equation can be used to calculate a tension in the cable 404: CT=MT/(2×cos θ). CT is the cable tension and MT is the measured strain sensed by the tension measuring devices 412, 413, either individually or as an average of the two measurements.

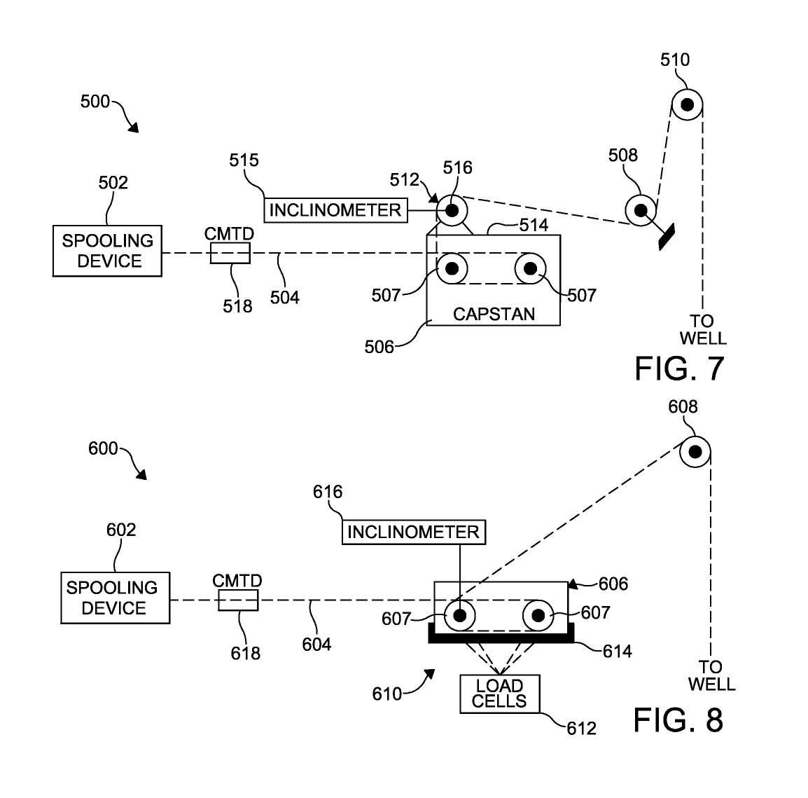

Referring now to FIG. 7, there is shown an embodiment of a tension measurement assembly indicated generally at 500 similar to the tension measurement assembly 300 except as described herein below. As shown, the assembly includes a spooling device 502 for spooling a cable 504, a capstan 506 having a plurality of multi-grooved wheels 507, a plurality of sheaves 508, 510 for directing the cable 504, and a tension measuring device 512.

The tension measuring device 512 includes a sheave mounted to a top surface 514 of the capstan 506 and an inclinometer 515. As a non-limiting example, the tension measuring devices 512 includes a strain axle 516 or load pin disposed therethrough to measure a force on the tension measuring device 512 due to a tension in the cable 504. An inclinometer 515 is disposed to measure a cable angle of the cable 504 relative to a pre-determined axis as the cable 504 exits the tension measuring device 512. As a non-limiting example, the inclinometer 515 may be a digital level manufactured by Johnson Level & Tool Mfg. Co., Inc. As a further non-limiting example, the tension measuring device is coupled to a fixed surface (i.e. anchor) via a tension link (not shown) similar to the link 114 shown in FIG. 3 spaced on the rig floor above the capstan.

In certain embodiments, a Cable-Mounted Tension Device (CMTD) 518 is coupled to the cable 504 between the spooling device 502 and the capstan 506 (i.e. the low tension side).

In use, the cable 504 is deployed and retrieved by the spooling device 502. As the cable 504 is routed through the capstan 506, the sheaves 508, 510, and the tension measuring device 512, a tension in the cable 504 exerts a force on the strain axle 516 of the tension measuring device 512. The tension in the cable 504 at the high tension side of the capstan 506 is computed using the force (i.e. strain force) measured by the strain axle 516 and the cable angle (0) measured by the inclinometer 515. As a non-limiting example the following equation can be used by the processor 122, 222 to calculate a tension in the cable 504: CT=MT/(2×cos θ). CT is the cable tension and MT is the measured strain sensed by the tension measuring device 512.

Referring now to FIG. 8, there is shown an embodiment of a tension measurement assembly indicated generally at 600 similar to the tension measurement assembly 300 except as described herein below. As shown, the assembly includes a spooling device 602 for spooling a cable 604, a capstan 606 having a plurality of multi-grooved wheels 607, a sheave 608 for directing the cable 604, and a tension measuring device 610.

The tension measuring device 610 includes a plurality of load cells 612 positioned to measure forces exerted on a platform 614 on which the capstan 606 is mounted. Specifically, the load cells 612 measure the upward and horizontal forces experienced by the capstan 606. An inclinometer 616 measures an angle of the cable 604 entering and leaving the capstan 606.

A Cable-Mounted Tension Device (CMTD) 618 is coupled to the cable 604 between the spooling device 602 and the capstan 606 (i.e. the low tension side) to measure a tension of the cable 604 entering the capstan 606.

In use, the cable 604 is deployed and retrieved by the spooling device 602. As the cable 604 is routed through the capstan 606 and the sheave 608 a tension in the cable 604 exerts forces on the capstan 606. The tension in the cable 604 is computed using the force (load force) measured by the load cells 612 and the CMTD 618 and an entrance/exit cable angle measured by the inclinometer 616.

As a non-limiting example the following equation can be used by the processor 122, 222 to calculate a tension in the cable 604: CT=MT/(2×cos θ). CT is the cable tension and MT is the measured strain sensed by the load cells 612.

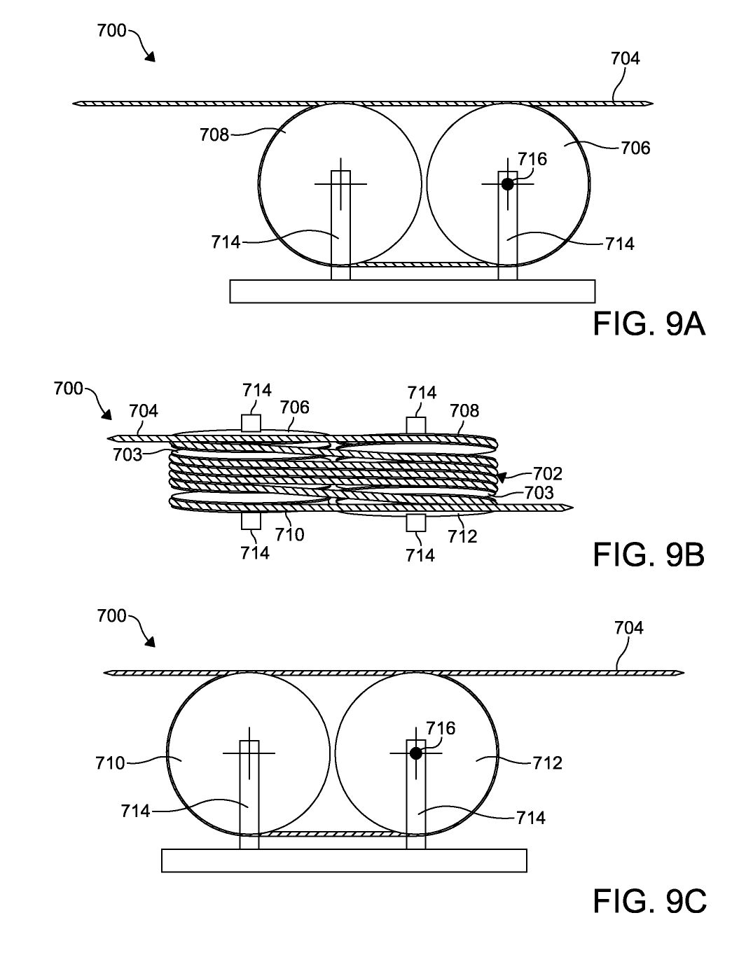

Referring now to FIGS. 9A, 9B, and 9C, there is shown an embodiment of a tension measurement assembly indicated generally at 700. As shown, the assembly includes a capstan 702 having a plurality of multi-grooved wheels 703 for guiding a cable 704 (e.g. high tension wireline) and a plurality of tension measuring devices 706, 708, 710, 712.

The tension measuring devices 706, 708, 710, 712 are freewheeling sheaves mounted on individual posts 714 adjacent the capstan 702. Each of the posts 714 supporting the tension measuring devices 706, 712 is instrumented with a strain gauge 716 (e.g. strain axle, load pin, tension link, etc.) to measure a force on the tension measuring devices 706, 712 caused by a tension in the cable 704. Any number of the tension measuring devices 706, 708, 710, 712 can include a means for measuring a force exerted thereon. As shown, tension measuring devices 706, 708, 710, 712 may be the same diameter as the wheels 703 of the capstan 702, thereby eliminating potential damage caused by small wheels and pinch wheels too close. The angles between the cable 704 exiting the tension measuring devices 706, 708, 710, 712 are fixed and known, so any error caused by not having the ends of the cable 704 perfectly parallel can easily be corrected in software, as will be appreciated by those skilled in the art. It is understood that the tension measuring devices 706, 708, 710, 712 can be offset to clear a structure of the capstan 702.

In use, the cable 704 enters an area near the tension measuring device 712. However, the cable 704 is not initially engaged by the tension measuring device 712 Rather, the cable 704 wraps around tension measuring device 710 before entering tension measuring device 712. Because tension measuring device 710 is freewheeling, the cable 704 entering tension measuring device 712 is still experiencing a full line tension. Accordingly, the strain gauge 716 measures a force exerted on the tension measuring device 712.

After exiting tension measuring device 712 the cable 704 enters the capstan 702 and a tension in the cable 704 is reduced to the nominal spooling tension for a storage drum (not shown) on the truck. Departing the capstan 702, the cable 704 enters the freewheeling tension measuring device 706 and then departs the “area” via the freewheeling tension measuring device 708. It is understood that the cable 704 exiting the tension measuring device 708 is spaced from the tension measuring device 706. Accordingly, the strain gauge 716 measures a force exerted on the tension measuring device 706 as the cable 704 moves to the drum.

The tension in the cable 704 is computed using the force (i.e. strain force) measured by at least one of the strain gauges 716 and an entrance/exit cable angle (θ) of the cable 704 to/from at least one of the tension measuring devices 706, 712. As a non-limiting example the following equation can be used by the processor 122, 222 to calculate a tension in the cable 704: CT=MT/(2×cos θ). CT is the cable tension and MT is the measured strain sensed by the strain gauges 716, either individually or as an average of the measurements.

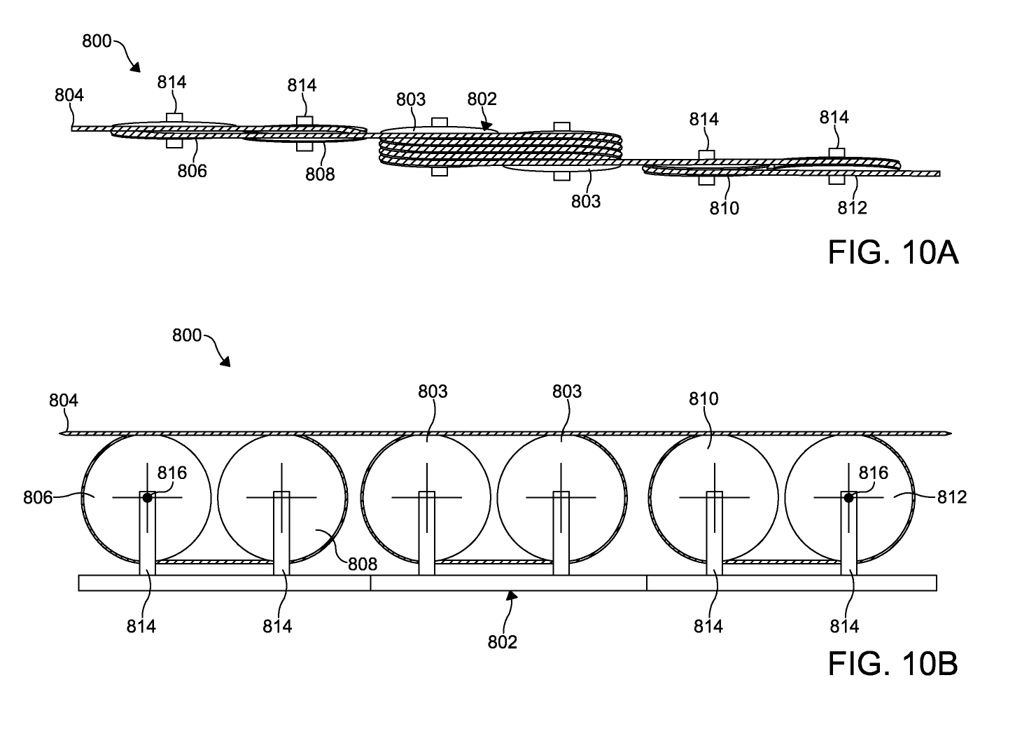

Referring now to FIGS. 10A and 10B, there is shown an eighth embodiment of a tension measurement assembly indicated generally at 800. As shown, the assembly 800 includes a capstan 802 having a plurality of multi-grooved wheels 803 for guiding a cable 804 and a plurality of tension measuring devices 806, 808, 810, 812.

As shown, the tension measuring devices 806, 808, 810, 812 are generally aligned with the capstan 802. However, the tension measuring devices 806, 808, 810, 812 may be disposed in any position relative to the capstan 802 such as above the capstan 802, for example. The tension measuring devices 806, 808, 810, 812 are freewheeling sheaves mounted on individual posts 814. The posts 814 supporting the tension measuring devices 806, 812 are instrumented with a strain gauge 816 (e.g. strain axle, load pin, tension link, etc.) to measure a force on the tension measuring devices 806, 812 caused by a tension in the cable 804. As shown, the tension measuring devices 806, 808, 810, 812 may be the same diameter as the wheels 803 of the capstan 802, thereby eliminating potential damage caused by small wheels and pinch wheels too close. The cable angles between the cable 804 exiting the tension measuring devices 806, 808, 810, 812 are fixed and known, so any error caused by not having the ends of the cable 804 perfectly parallel can easily be corrected in software, as will be appreciated by those skilled in the art. It is understood that the tension measuring devices 806, 808, 810, 812 maybe offset to clear a structure of the capstan 802.

In use, the cable 804 enters an area near the tension measuring device 812. However, the cable 804 is not initially engaged by the tension measuring device 812 Rather, the cable 804 wraps around tension measuring device 810 before entering tension measuring device 812. Because tension measuring device 810 is freewheeling, the cable 804 entering tension measuring device 812 is still experiencing a full line tension. Accordingly, the strain gauge 816 measures a force exerted on the tension measuring device 812.

After exiting tension measuring device 812 the cable 804 enters the capstan 802 and a tension in the cable 804 is reduced to the nominal spooling tension for a storage drum (not shown) on the truck. Departing the capstan 802, the cable 804 enters the freewheeling tension measuring device 806 and then departs the “area” via the freewheeling tension measuring device 808. It is understood that the cable 804 exiting the tension measuring device 808 is spaced from the tension measuring device 806. Accordingly, the strain gauge 816 measures a force exerted on the tension measuring device 806 as the cable 804 moves to the drum.

The tension in the cable 804 is computed using the force (i.e. strain force) measured by at least one of the strain gauges 816 and an entrance/exit cable angle (θ) of the cable 804 to/from at least one of the tension measuring devices 806, 812. As a non-limiting example the following equation can be used by the processor 122, 222 to calculate a tension in the cable 804: CT=MT/(2×cos θ). CT is the cable tension and MT is the measured strain sensed by the strain gauges 816, either individually or as an average of the measurements.

The embodiments disclosed herein offer more accurate alternatives for dealing with and measuring increasing cable tensions in, for example, increasingly deeper wells, such as a wellbore penetrating a subterranean formation. The embodiments disclosed herein may be utilized with wellbore cables for use with wellbore devices to perform operations in wellbores penetrating geologic formations that may contain gas and oil reservoirs. The cables may be used to interconnect well logging tools, such as gamma-ray emitters/receivers, caliper devices, resistivity-measuring devices, seismic devices, neutron emitters/receivers, and the like, to one or more power supplies and data logging equipment outside the well. The cables may also be used in seismic operations, including subsea and subterranean seismic operations. A capstan is used to alleviate tension encountered by the take up spool on the winch. In some embodiments, fixedly-mounted tension-measuring sheaves are used to eliminate the need for angle measurement in calculating tension levels.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

We claim:

1. A tension measurement assembly for measuring and monitoring a tension force in a cable being deployed from a spooling device on which the cable is spooled, the cable traveling through a capstan for directing the cable to a downstream point, comprising:
at least one tension measuring device fixed relative to the cable for sensing a tension force in the cable adjacent an exit of the cable from the capstan and for generating a tension signal representing the sensed tension force; and
a processor responsive to said tension signal and to a cable angle of the cable at said at least one tension measuring device for calculating and monitoring a tension force present in the cable.

2. The assembly of claim 1 wherein said at least one tension measuring device comprises a tension link attached to a sheave engaging the cable for generating said tension signal.

3. The assembly of claim 1 wherein said at least one tension measuring device comprises an inclinometer for generating an angle signal representing the cable angle to said processor.

4. The assembly of claim 1 wherein said at least one tension measuring device comprises a tension measuring sheave having a strain axle for generating the tension signal.

5. The assembly of claim 4 wherein said tension measuring sheave is mounted to a top of the capstan.

6. The assembly of claim 4 wherein said tension measuring sheave is mounted to an exit side of the capstan.

7. The assembly of claim 1 further comprising a platform mounting the capstan, wherein said at least one tension measuring device includes a plurality of load cells attached to said platform for generating the tension signal.

8. The assembly of claim 1 wherein said at least one tension measuring device comprises at least one free-wheeling sheave mounted to a fixed surface and a strain gauge coupled to said at least one free-wheeling sheave for generating the tension signal.

9. A system for measuring and monitoring a tension force in a cable, comprising:
a spooling device for deploying and retrieving the cable spooled thereon;
a capstan having a plurality of multi-grooved wheels for directing the cable between said spooling device and a downstream point;
a tension measuring device adjacent an exit of the cable from said capstan and fixed relative to the cable for generating a tension signal indicative of a tension force in the cable; and
a processor for computing and monitoring the tension force in the cable in response to the tension signal and a cable angle of the cable at said tension measuring device.

10. The system of claim 9 wherein said tension measuring device comprises a tension link for generating the tension signal.

11. The system of claim 9 wherein said tension measuring device comprises an inclinometer for generating a cable signal representing the cable angle to said processor.

12. The system of claim 9 wherein said tension measuring device comprises a tension measuring sheave having a strain axle.

13. The system of claim 9 further comprising a platform mounting said capstan, wherein said tension measuring device comprises a plurality of load cells attached to said platform for generating the tension signal.

14. The system of claim 9 wherein said tension measuring device comprises at least one free-wheeling sheave mounted to a fixed surface and a strain gauge coupled to said at least one free-wheeling sheave for generating the tension signal.

15. A method for measuring and monitoring a tension force in a cable, comprising:
providing a spooling device for deploying and retrieving the cable;
directing the cable from the spooling device to a downstream point;
providing a tension measuring device coupled to a fixed surface and generating a tension signal indicative of a tension force in the cable; and
calculating the tension force in the cable based on the tension signal from the tension measuring device and a cable angle of the cable at the tension measuring device.

16. The method of claim 15 wherein the tension measuring device comprises a tension link generating the tension signal.

17. The method of claim 15 wherein the tension measuring device comprises an inclinometer generating the cable angle.

18. The method of claim 15 wherein the tension measuring device comprises a tension measuring sheave having a strain axle.

19. The method of claim 15 wherein the step of directing the cable comprises providing a capstan engaging the cable and mounted on a platform, wherein the tension measuring device includes a plurality of load cells attached to the platform for generating the tension signal.

20. The method of claim 15 wherein the tension measuring device includes at least one free-wheeling sheave engaging the cable and mounted to a fixed surface and a strain gauge coupled to the at least one free-wheeling sheave for generating the tension signal.
